(19) United States
(12) Patent Application Publication
(10) Pub. No.: US 2008/0018602 A1
(43) Pub. Date: Jan. 24, 2008

(54) OPTICAL MOUSE

(75) Inventors: Chu-Ming Cheng, Hsinchu (TW); Shang-Yi Wu, Hsinchu (TW)

Correspondence Address: J C PATENTS, INC., 4 VENTURE, SUITE 250, IRVINE, CA, 92618, US

(73) Assignee: Young Optics Inc., Hsinchu (TW)

(21) Appl. No.: 11/749,551

(22) Filed: May 16, 2007

(30) Foreign Application Priority Data
Jul. 18, 2006 (TW) 95126165

(51) Int. Cl. G06F 3/033

(52) U.S. Cl. 345/166

(57) ABSTRACT

An optical mouse suitable for being put on a surface of an object and including a light source, an image sensor, and a total internal reflection (TIR) prism is provided. The light source is suitable for emitting a light beam, and the TIR prism is disposed between the surface of the object and image sensor located on an optical path of the light beam. The TIR prism has an air gap which reflects the light beam emitted from the light source to the surface. Next, the light beam is reflected by the surface back to the TIR prism, and the light beam reflected by the surface passes through the air gap to be captured by the image sensor. Additionally, an optical mouse using Michelson interference principle is provided. The above-mentioned optical mice improve the accuracy when capturing images and reduce the probability of incorrect image judgment.

### CROSS-REFERENCE TO RELATED APPLICATION

This application claims the priority benefit of Taiwan application serial no. 95126165, filed Jul. 18, 2006. All disclosure of the Taiwan application is incorporated herein by reference.

### BACKGROUND OF THE INVENTION

1. Field of Invention

The present invention relates to a mouse. More particularly, the present invention relates to an optical mouse.

2. Description of Related Art

Optical mouse are suitable for being put on a surface and has an internal image sensor to capture images of the surface. In accordance with the changes of the captured images caused by the moving of the mouse, a cursor on the screen moves correspondingly (e.g., the moving direction, distance and speed). However, the sensitivity and accuracy of the moving of the cursor on the screen is decided by whether the image sensor can capture the images of the surface precisely.

Referring to FIG. 1, an optical system 100 of a conventional laser optical mouse includes a laser diode (LD) light source 110, a lens portion A, a lens portion B, and an image sensor 130. The LD light source 110 is suitable for generating a laser light beam 112, and the lens portion A and lens portion B are used for condensing the laser light beam 112 to improve the collimation of the laser light beam 112. In particular, after being emitted from the LD light source 110, the laser light beam 112 is condensed by the lens portion A and is projected onto a surface 140. Next, the laser light beam 112 is reflected by the surface 140 so as to generate a reflected light beam 144. The reflected light beam 144 is further condensed by the lens portion B, and is projected on the image sensor 130. Thus, the image sensor 130 captures the image of the surface 140. When a user moves the laser optical mouse, the image captured by the image sensor 130 changes accordingly. The change of the image captured by the image sensor 130 is calculated and processed by a circuit unit (not shown) inside the laser optical mouse, and the corresponding moving direction, displacement and speed of the cursor on the screen is then determined. Thus, the user can move the cursor on the screen through moving the laser optical mouse.

As the laser light beam 112 generated by the LD light source 110 is projected onto the surface 140 obliquely, an oval light spot is formed on the surface 140, and thus the image captured by the image sensor 130 is also oval-shaped. As such, the image reflected to the image sensor 130 is distorted (i.e., a circular image is changed to be an oval image), and the condition of the surface 140 cannot be transmitted to the image sensor 130 completely and precisely, such that the accuracy of the laser optical mouse in terms of image capture is lowered.

Moreover, as the laser light beam 112 is projected obliquely, and the light paths of the laser light beam 112 and the reflected light beam 144 are separated, the entire optical transmission system cannot be miniaturized. In addition, the requirements for the optical characteristics of the surfaces of lens structures of the lens portion A and the lens portion B are quite strict, so it is difficult to fabricate, and the cost is high.

Furthermore, ROC Utility Model Patent No. M275477 has disclosed another conventional optical mouse, which adopts a beam splitting surface and makes use of the transflective principle, so as to forward project the light beam from a light source onto an image detecting surface. However, the intensity of the light beam captured by an image sensor is approximately one fourth of the original intensity of the light beam, and thus the brightness of the image captured by the image sensor is low, influencing the accuracy of the optical mouse in terms of image capture. Moreover, the light guide body and the imaging lens in the optical system are integrated into one-piece, so it is difficult to fabricate, and the cost is high.

### SUMMARY OF THE INVENTION

The present invention is directed to provide an optical mouse to improve the accuracy of the optical mouse in terms of image capture and to reduce the probability of incorrect judgment of the optical mouse.

The present invention is to provide an optical mouse using Michelson interference principle to improve the accuracy of the optical mouse in terms of image capture and to reduce the probability of incorrect judgment of the optical mouse.

As broadly embodied and described herein, the present invention provides an optical mouse suitable for being put on a surface. The optical mouse comprises a light source, an image sensor, and a prism. The light source is suitable for emitting a light beam, and the prism is disposed between the surface and the image sensor and is located on the optical path of the light beam. The prism comprises a gap and a total reflection surface inside. The gap is used for forming the total reflection surface. The total reflection surface reflects the light beam onto the surface. After the light beam is reflected back to the prism by the surface, the light beam passes through the gap and is projected onto the image sensor, such that the image sensor captures the image of the surface.

As broadly embodied and described herein, the present invention further provides an optical mouse suitable for being put on a surface. The optical mouse comprises a light source, an image sensor, a dichroic mirror, and a reflector. The light source is suitable for emitting a light beam, and the dichroic mirror is disposed between the surface and the image sensor and is located on the optical path of the light beam. The dichroic mirror separates the light source into a reflected light beam and a transmitted light beam. The reflected light beam is transmitted onto the surface, and the reflected light beam is reflected back to the dichroic mirror by the surface, and then the reflected light beam passes through the dichroic mirror and is projected onto the image sensor. The reflector is disposed on the optical path of the transmitted light beam, and reflects the transmitted light beam back to the dichroic mirror. Then, the dichroic mirror reflects the transmitted light beam to the image sensor, and the transmitted light beam and the reflected light beam between the dichroic mirror and the image sensor form an interference fringe. In an embodiment of the present invention, the optical mouse further comprises an optical compensated lens disposed between the dichroic mirror and the reflector and being located on the optical path of the transmitted light beam.

As the light beam emitted from the light source is projected on the surface of an object vertically, and eventually is projected on the image sensor vertically, the image captured by the image sensor is not distorted. Therefore, the optical mouse of the present invention has higher operation accuracy as compared with the conventional optical mouse, and the probability of incorrect judgment of the image sensor thereof is lowered as well.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic view of the optical path of the conventional laser optical mouse.

FIG. 2A is a schematic view of the optical system of the optical mouse according to the first embodiment of the present invention.

FIGS. 2B to 2I are schematic views of the optical system of the optical mouse according to the first embodiment of the present invention.

FIG. 3A is a schematic view of the optical system of the optical mouse according to the second embodiment of the present invention.

FIG. 3B is a schematic view of the optical system of the optical mouse having lenses according to the second embodiment of the present invention.

FIG. 3C is a schematic view of the optical system of the optical mouse having the optical compensated lens according to the second embodiment of the present invention.

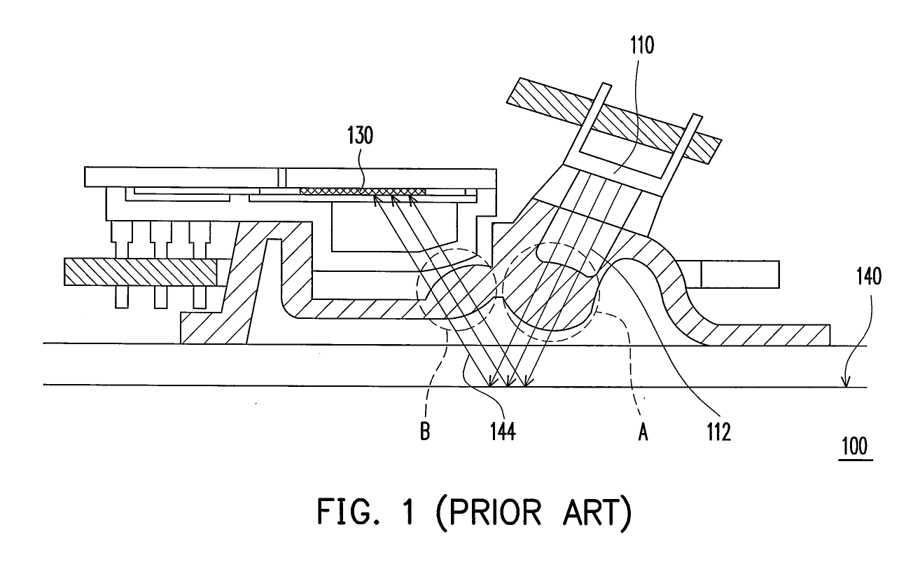

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

### The First Embodiment

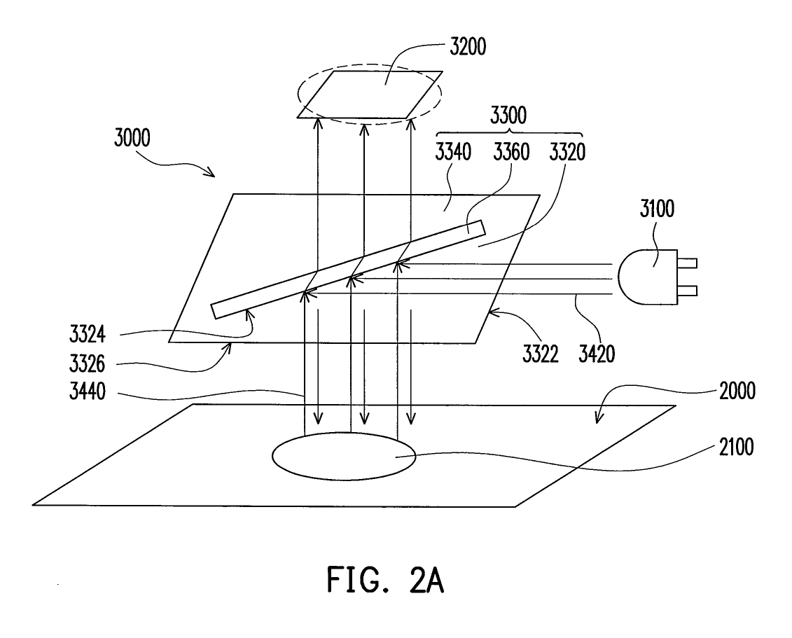

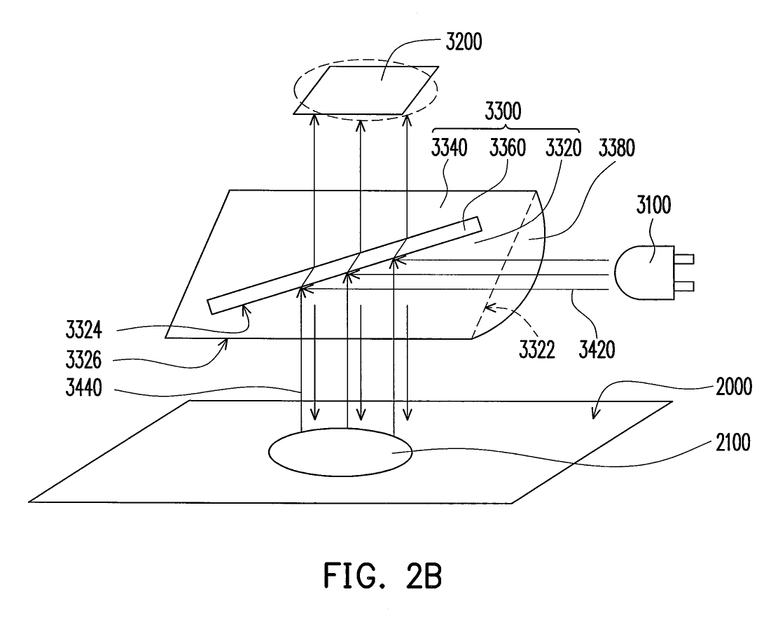

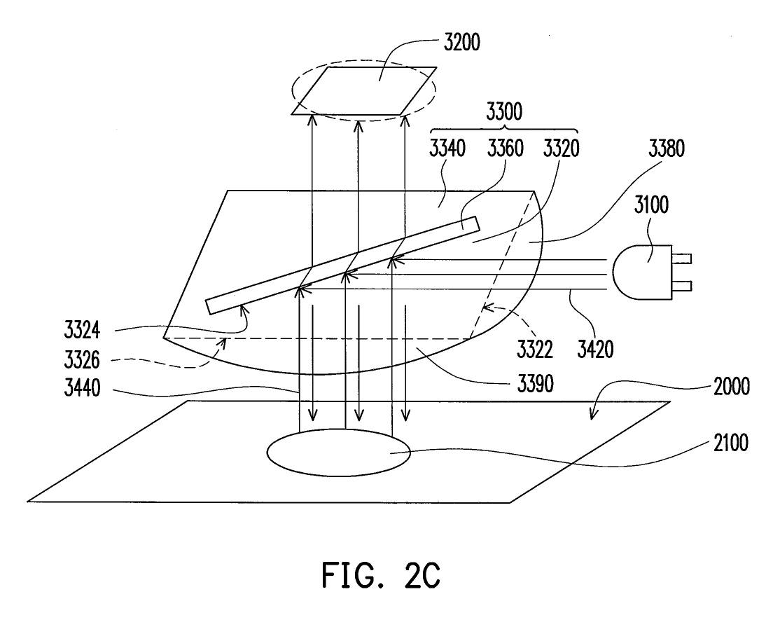

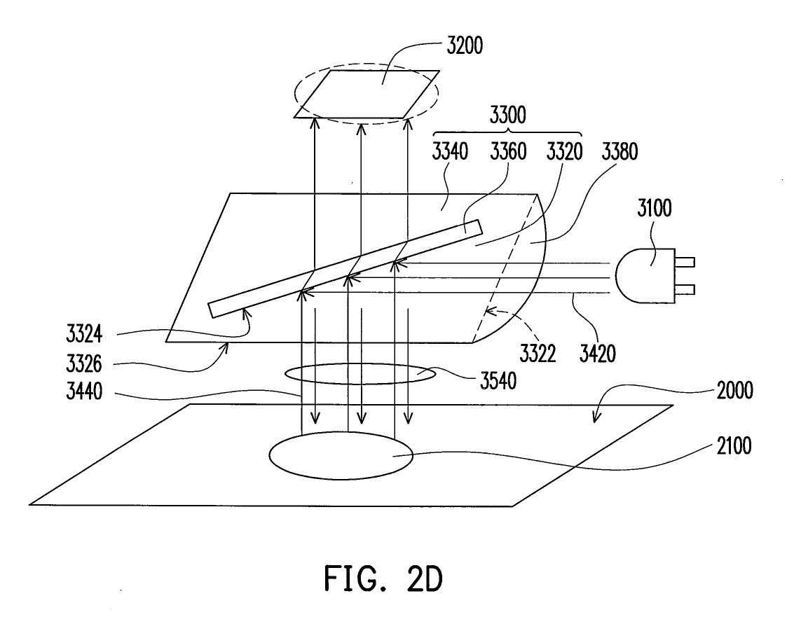

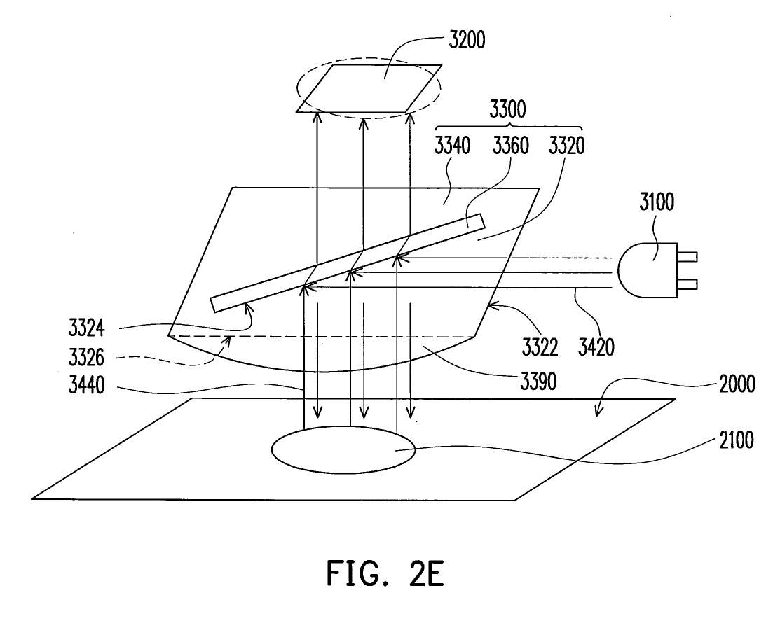

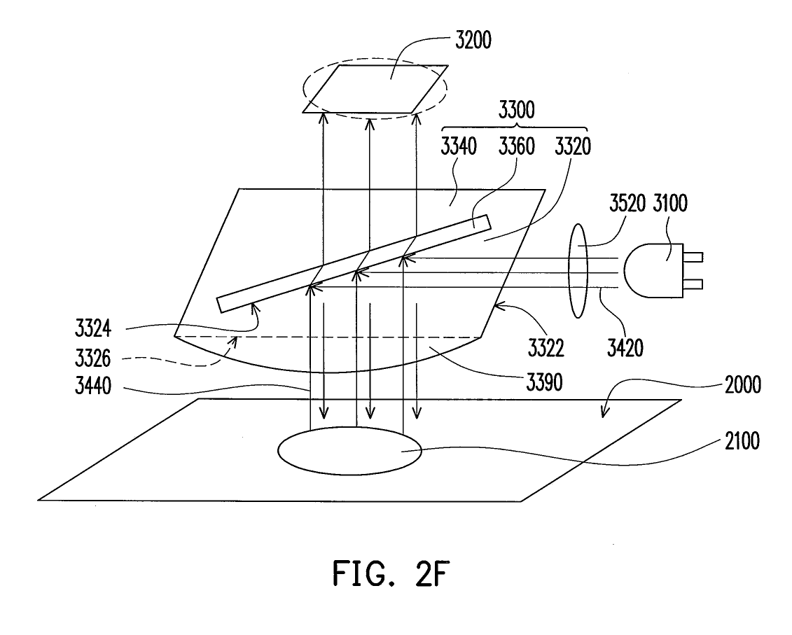

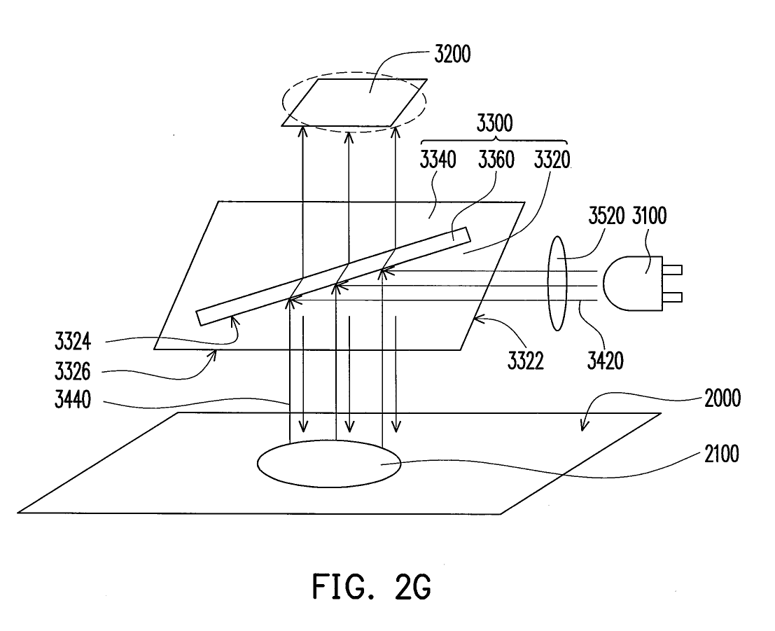

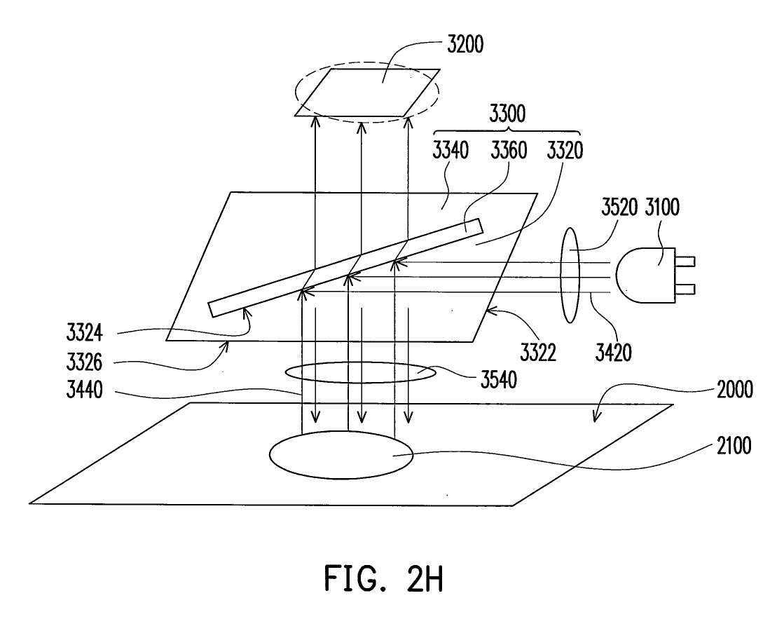

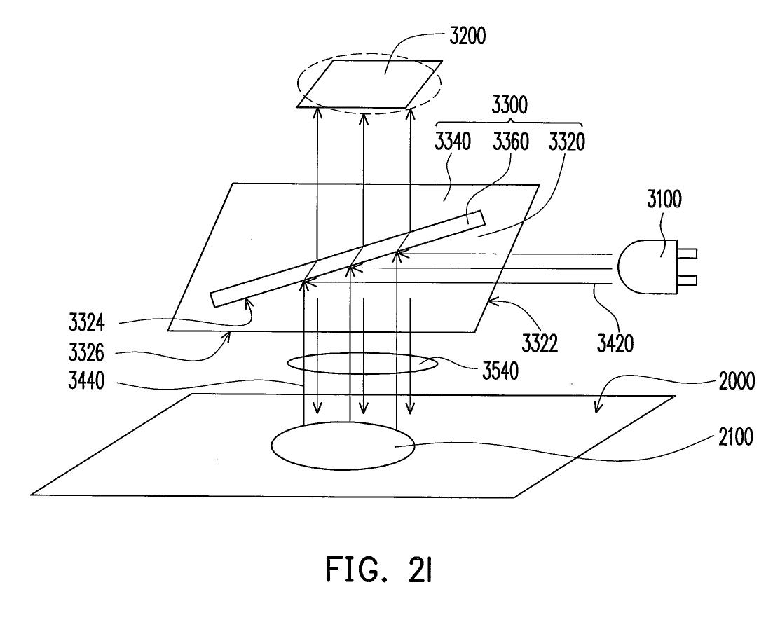

FIG. 2A is a schematic view of the optical system of the optical mouse according to the first embodiment of the present invention. Referring to FIG. 2A, the optical mouse is suitable for being put on a surface 2000, and the optical system 3000 includes a light source 3100, an image sensor 3200, and a prism 3300. The light source 3100 is, for example, a light emitting diode or a laser diode, and is suitable for emitting a light beam 3420. The image sensor 3200 is, for example, a CCD or a CMOS image sensor. The prism 3300 is, for example, a TIR prism.

The prism 3300 is disposed between the surface 2000 and the image sensor 3200, and is located on the optical path of the light beam 3420. The prism 3300 includes a first prism 3320, a second prism 3340, and a gap 3360. The first prism 3320 has a light-incident surface 3322, a total reflection surface 3324, and a light-emerging surface 3326. The light beam 3420 emitted from the light source 3100 enters the first prism 3320 from the light-incident surface 3322, and leaves the first prism 3320 from the light-emerging surface 3326 after being reflected by the total reflection surface 3324. The light beam 3420 leaving from the light-emerging surface 3326 is projected onto the surface 2000 vertically, so as to form a light spot 2100.

The second prism 3340 is joined with the first prism 3320, and the gap 3360 is disposed between the first prism 3320 and the second prism 3340. The gap contains a medium inside, and the refractive index of the medium is lower than the refractive indexes of the first prism 3320 and the second prism 3340, such that the total reflection surface 3324 is formed on the basis of the difference between the refractive indexes. Then, the surface 2000 at the light spot 2100 reflects the light beam 3420, and forms a light beam 3440. Next, the light beam 3440 passes through the first prism 3320, the gap 3360, and the second prism 3340, and is projected onto the image sensor 3200 vertically, such that the image sensor 3200 captures the image of the surface 2000.

The optical system 3000 of the present invention adopts the prism 3300 to form a special optical path design. Therefore, the light beam 3420 can be projected onto the surface 2000 vertically, and the shape of the light spot 2100 can be the same as that of the light source 3100, for example, a round shape. The light beam 3440 is also projected onto the image sensor 3200 vertically, so the image captured by the image sensor 3200 can have the same shape as that of the light spot 2100, and is not distorted. Thus, the condition of the surface 2000 can be transmitted to the image sensor 3200 completely and precisely. The prism 3300 can almost totally reflect the light beam 3420 emitted from the light source 3100, so the light spot 2100 projected on the surface 2000 can have higher brightness. Therefore, the optical mouse of the present invention has higher accuracy as compared with the conventional optical mouse in terms of image capture, and the probability of incorrect judgment of the image sensor is lowered as well. In addition, the optical mouse of the present invention adopts the TIR prism with a simpler structure to replace the conventional lens portion, so it is easy to fabricate, and the cost is lower. Furthermore, the light beam 3420 is projected onto the surface 2000 vertically, such that the reflected light beam 3440 is partially overlapped with the optical path of the light beam 3420, thus reducing the size of the optical system.

In addition, in order to improve the collimation of the light beams (e.g., the light beam 3420 or the light beam 3440), lenses can be added into the optical system, for example, a lens 3380 disposed on the light-incident surface 3322 of the total reflection prism 3300 (as shown in FIGS. 2B, 2C, and 2D), a lens 3390 disposed on the light-emerging surface 3326 of the total reflection prism 3300 (as shown in FIGS. 2C, 2E, and 2F), a lens 3520 disposed between the light-incident surface 3322 of the total reflection prism 3300 and the light source 3100 (as shown in FIGS. 2F, 2G, and 2H), a lens 3540 disposed between the light-emerging surface 3326 of the total reflection prism 3300 and the surface 2000 (as shown in FIGS. 2D, 2H, and 2I), or the combination thereof.

As the optical mouse of the present embodiment employs the prism 3300, and the prism 3300 or the lenses are separately or directly assembled in the optical mouse, the assembly procedure can be simplified.

### The Second Embodiment

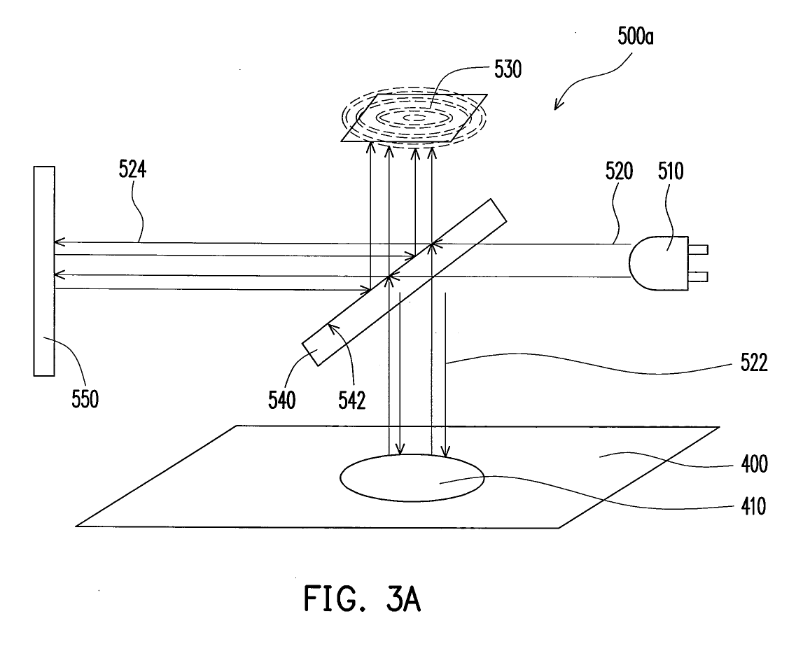

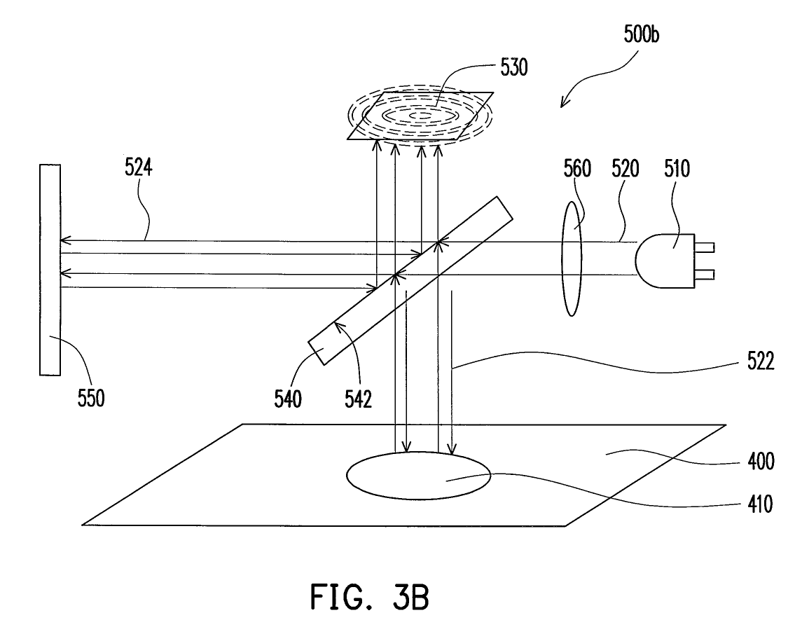

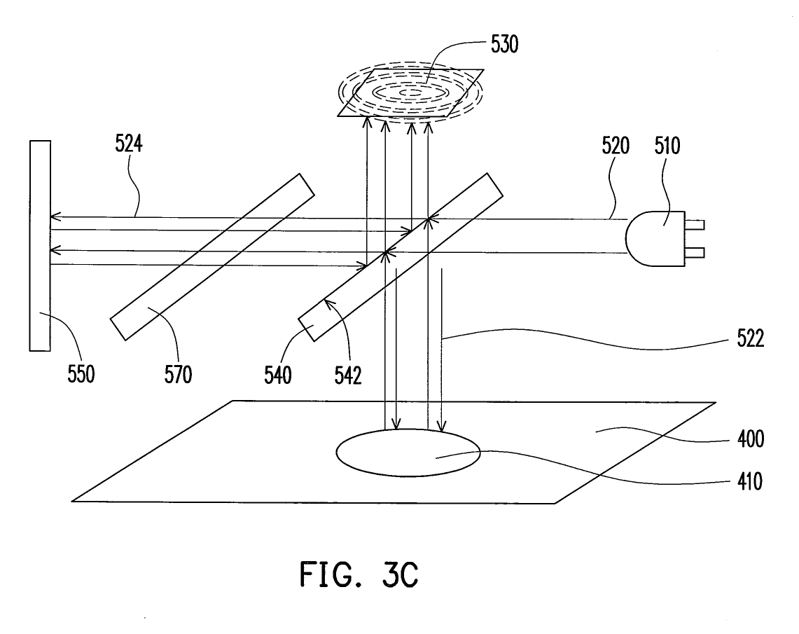

FIG. 3A is a schematic view of the optical system of the optical mouse according to the second embodiment of the present invention. Referring to FIG. 3A, the optical system 500a is suitable for being put on a surface 400, and includes a light source 510, an image sensor 530, a dichroic mirror 540, and a reflector 550. The light source 510 is, for example, a light emitting diode or a laser diode, and is suitable for emitting a light beam 520. The dichroic mirror 540 is disposed between a surface 400 of the object and the image sensor 530, and is located on the optical path of the light beam 520. The image sensor 530 is, for example, a CCD or a CMOS image sensor. The dichroic mirror 540 has a beam splitting surface 542. When the light beam 520 is irradiated on the beam splitting surface 542, a part of the light beam 520 is reflected, and the other part of the light beam 520 is transmitted through the beam splitting surface 542. The transmission to the reflection ratio is 1:1 or other ratios, so the beam splitting surface 542 can be a transflective surface. Thus, the dichroic mirror 540 separates the light source 510 into a reflected light beam 522 and a transmitted light beam 524. The reflected light beam 522 is transmitted to the surface 400, and forms a light spot 410 on the surface 400. Then, the reflected light beam 522 is reflected by the surface 400, and then the reflected light beam 522 passes through the dichroic mirror 540 and is transmitted onto the image sensor 530. The reflector 550 is disposed on the optical path of the transmitted light beam 524, and the transmitted light beam 524 is reflected back to the dichroic mirror 540 by the reflector 550. The transmitted light beam 524 is then reflected onto the image sensor 530 by the dichroic mirror 540. It should be noted that the transmitted light beam 524 and the reflected light beam 522 between the dichroic mirror 540 and the image sensor 530 may interfere with each other, thus forming an interference fringe on the image sensor 530, i.e. the application of Michelson interference principle in the optical mouse. When the optical mouse moves on the surface 400, the interference fringe captured by the image sensor 530 changes accordingly. The circuit unit (not shown) inside the optical mouse calculates and processes the change to decide the corresponding direction and displacement of the moving of the cursor on the screen. As the image sensor 530 captures the interference fringe, while the conventional optical mouse captures a light spot only, the optical mouse of the present invention has higher accuracy than the conventional optical mouse in terms of image capture. Moreover, as the reflected light beam 522 can be forward projected on the surface 400, the interference fringe captured by the image sensor 530 is not distorted. Therefore, the optical mouse of the present invention has higher accuracy than the conventional art in terms of image capture. Furthermore, compared with the conventional optical mouse using the transflective principle in which a part of the incident light from the light source is directly transmitted through the beam splitting surface and cannot be used, the optical mouse of the present embodiment further includes a reflector 550, so that the transmitted light beam 524 being transmitted through the beam splitting surface 542 is reflected back to the beam splitting surface 542 and is eventually transmitted to the image sensor 530 to be used. Therefore, the optical mouse of the present embodiment uses the light source 510 more effectively to improve the accuracy of image capture.

Moreover, referring to FIG. 3B, the optical system 500b further includes a lens 560 disposed between a light source 510 and a dichroic mirror 540 and being located on the optical path of the light beam 520 to improve the collimation of the light beam 520. In particular, the lens 560 is suitable for the light source 510 with poor collimation, for example, the light source 510 using light emitting diodes.

When the light beam 520 emitted from the light source 510 has a wide bandwidth or is formed by the mixture of lights with different wavelengths, as the dispersion caused by the dichroic mirror 540 may lead to the change of the optical paths of the reflected light beam 522 and the transmitted light beam 524 according to different wavelengths, the interference fringe become vague. Therefore, referring to FIG. 3C, an optical compensated lens 570 can be added between the dichroic mirror 540 and the reflector 550 to solve the aforementioned problem.

As the optical mouse of the present embodiment does not have a lens portion, compared with the conventional optical mouse, the optical mouse of the present embodiment can be easily manufactured, and the manufacturing cost is low. In addition, the independent dichroic mirror 540, the lens 560, and the optical compensated lens 570 can be separately or directly assembled in the optical mouse to simplify the assembly procedure.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An optical mouse suitable for being put on a surface, comprising:
a light source, suitable for emitting a light beam;
an image sensor; and
a lens, disposed between the surface and the image sensor and being located on an optical path of the light beam, wherein the lens has a gap and a total reflection surface inside, the gap is used for forming the total reflection surface, the total reflection surface reflects the light beam to the surface, after the light beam reflected by the surface back to the prism, the light beam passes through the gap and is projected onto the image sensor, such that the image sensor captures the image of the surface.

2. The optical mouse as claimed in claim 1, wherein the light source comprises a light emitting diode.

3. The optical mouse as claimed in claim 1, wherein the light source comprises a laser diode.

4. The optical mouse as claimed in claim 1, the image sensor comprises a charge coupled device (CCD) or a complementary metal oxide semiconductor (CMOS) image sensor.

5. The optical mouse as claimed in claim 1, wherein after the light beam reflected by the total reflection surface, the light beam is projected onto the surface vertically, and after the light beam reflected by the surface back to the prism, the light beam passes through the gap and is projected onto the image sensor vertically.

6. The optical mouse as claimed in claim 1, wherein the prism comprises:
a first prism, comprising a light-incident surface and a light-emerging surface, wherein the light beam emitted from the light source enters the first prism from the light-incident surface, and leaves the first prism from the light-emerging surface to be irradiated on the surface after being reflected by the total reflection surface; and
a second prism, joined with the first prism, wherein the gap is disposed between the first prism and the second prism, the light beam reflected by the surface passes through the first prism, the gap, and the second prism to be captured by the image sensor.

7. The optical mouse as claimed in claim 6, further comprising a lens disposed on the light-incident surface, on the light-emerging surface, between the light-incident surface and the light source, or between the light-emerging surface and the surface.

8. The optical mouse as claimed in claim 6, wherein the gap comprises a medium inside, and a refractive index of the medium is lower than refractive indexes of the first lens and the second lens.

9. An optical mouse suitable for being put on a surface, comprising:
a light source, suitable for emitting a light beam;
an image sensor;
a dichroic mirror, disposed between the surface and the image sensor and being located on the optical path of the light beam, wherein the dichroic mirror separates the light source into a reflected light beam and a transmitted light beam, the transmitted light beam is transmitted to the surface, and the reflected light beam reflected by the surface back to the dichroic mirror, and then the reflected light beam passes through the dichroic mirror to be projected onto the image sensor; and
a reflector, disposed on the optical path of the transmitted light beam, wherein the reflector reflects the transmitted light beam back to the dichroic mirror, then the transmitted light beam reflected by the dichroic mirror to the image sensor, and the transmitted light beam and the reflected light beam between the dichroic mirror and the image sensor form an interference fringe.

10. The optical mouse as claimed in claim 9, wherein the light source comprises a light emitting diode.

11. The optical mouse as claimed in claim 9, wherein the light source comprises a laser diode.

12. The optical mouse as claimed in claim 9, the image sensor comprises a CCD or a CMOS image sensor.

13. The optical mouse as claimed in claim 9, wherein the reflected light beam is projected onto the surface and the image sensor vertically.

14. The optical mouse as claimed in claim 9, further comprising a lens disposed between the light source and the dichroic mirror and being located on the optical path of the light beam.

15. The optical mouse as claimed in claim 9, further comprising an optical compensated lens disposed between the dichroic mirror and the reflector and being located on the optical path of the transmitted light beam.
